(19) United States
(12) Patent Application Publication
(10) Pub. No.: US 2012/0025027 A1
(43) Pub. Date: Feb. 2, 2012

(54) System for Air Borne Deployment of Palletized Cargo

(75) Inventors: Tom Yandle, Palmetto, FL (US); Michael E. Kelley, Seminole, FL (US); Elizabeth M. Rinehart, Seminole, FL (US)

(73) Assignee: CONAX FLORIDA CORPORATION, St. Petersburg, FL (US)

(21) Appl. No.: 13/173,157

(22) Filed: Jun. 30, 2011

Related U.S. Application Data
(60) Provisional application No. 61/360,745, filed on Jul. 1, 2010.

(51) Int. Cl. B64D 1/10; B60P 7/16; B64D 17/38

(52) U.S. Cl. 244/137.1; 410/87; 410/4

(57) ABSTRACT

Disclosed is a system for the airborne deployment and delivery of palletized cargo. The system includes a cargo pallet, one or more risers connected to the pallet, and an associated rigging. The risers are used in both stabilizing the cargo and in cushioning the impacts associated with transport and landing. The rigging is used to secure the pallet to one or more parachutes that are deployed as the pallet leaves the aircraft.

### CROSS-REFERENCE TO RELATED APPLICATIONS

This application claims priority to co-pending application Ser. No. 61/360,745 entitled “System for Air Borne Deployment of Palletized Cargo” filed on Jul. 1, 2010. The contents of this co-pending application are fully incorporated herein for all purposes.

### TECHNICAL FIELD

This disclosure relates to a system for the airborne deployment of palletized cargo. More specifically, the disclosure relates to system for securing and protecting cargo upon an air dropped pallet.

### BACKGROUND OF THE INVENTION

Air dropping cargo is a common means of delivering heavy equipment to isolated or otherwise inaccessible areas. The cargo is secured to a pallet or platform that is dropped from an aircraft. A parachute rigging, in turn, is secured to the pallet, and the parachute is used to slow the decent of the cargo. A variety of methods are currently used for air dropping cargo, including extraction, gravity and bundled drops. In an extraction drop, a first extraction chute is deployed behind the pallet. Once the extraction chute fills with air, the pallet is dragged out of the rear of the aircraft. In a gravity drop, the pallet rides on skids or rollers with the attitude of the aircraft assisting the pallet out of the vehicle. Gravity drop systems may use the Container Delivery System (CDS) bundle found in many military transports. Finally, in a bundled drop, the pallet is simply pushed out of the aircraft by one or more crewmen. In each instance, additional parachutes are subsequently deployed to slow the pallet's decent. The primary purpose of the parachute is to lessen the impact associated with landing and prevent damage to the cargo.

However, regardless of the deployment method used, there are a number of concerns associated with air dropping cargo. The first concern involves properly restraining the cargo. The cargo must be adequately secured to the pallet, as unrestrained cargo poses a significant danger to crewmembers, the aircraft, as well as the cargo. Moreover, the pallet and attached cargo undergo significant forces upon deployment of the parachute. Without properly securing the cargo, these forces might separate the pallet from the cargo upon chute deployment.

Another concern is landing impact. Namely, even with a parachute assisted landing, the forces encountered by the cargo upon ground impact can be substantial. These forces are magnified with heavier cargo. Without proper cushioning, these impact forces would damage expensive or otherwise valuable equipment. Protecting equipment is especially important in battlefield settings, as solders on the ground may have a pressing need for the equipment.

Still yet another concern with air dropped cargo is the speed with which cargo can be palletized and/or de-palletized. Presently, it takes a considerable amount of time to properly secure cargo prior to deployment. Likewise, once on the ground, solders must spend valuable time extracting the equipment from the pallet.

Thus, there exists a need for a system whereby cargo can be rapidly secured to, or unsecured from, an air dropped pallet. There likewise exists a need for cushioning the impacts associated with landing so as to protect expensive or otherwise valuable equipment. The system disclosed herein is aimed at fulfilling these as well as other needs.

### SUMMARY OF THE INVENTION

One of the advantages of the present system is that air dropped cargo can be more effectively restrained and secured both prior to, during, and after airborne deployment.

Another advantage of the present system is that air dropped cargo can be more effectively isolated from the forces associated with landing.

Still yet another advantage is that cargo can be quickly palletized and de-palletized to thereby minimize the time required to load and unload cargo.

Still yet another advantage is the ability to permit vehicles to be driven onto and off of the pallet to minimize the effort needed to prepare for a mission.

Another advantage is achieved by loading the cargo on risers that are designed for durability and reuse.

Various embodiments of the invention may have none, some, or all of these advantages. Other technical advantages will be readily apparent to one skilled in the art.

### BRIEF DESCRIPTION OF THE DRAWINGS

For a more complete understanding of the present disclosure and its advantages, references is now made to the following detailed description and the accompanying drawings, of which:

FIG. 1 is a perspective view of the system of the present invention, including left and right side riser platforms.

FIG. 2 is a perspective front side view of an inflated riser employed in the system of the present invention.

FIG. 3 is a perspective rear side view of an inflated riser employed in the system of the present invention.

FIG. 4 is a perspective back side view of a deflated riser employed in the system of the present invention.

FIG. 5 is a perspective front side view of a deflated riser employed in the system of the present invention.

FIG. 6 is a perspective overhead view of the system in its deflated state with a vehicle being driven off the risers.

FIG. 7 is a perspective overhead view of the system with the risers in the elevated orientation.

FIG. 8 is a side elevational view of the system with the pallet being withdrawn from an aircraft via an extraction chute.

FIG. 9 is a perspective view of the system with the parachutes fully deployed.

FIG. 10 is a perspective view of an alternative embodiment wherein the risers support the frame of the vehicle instead of the vehicle tires.

FIG. 11 is a perspective view of an alternative embodiment, wherein the risers are used in supporting boxed cargo.

Similar reference numerals refer to common elements throughout the several figures of the drawings.

### DETAILED DESCRIPTION OF THE DRAWINGS

The present disclosure relates to a system for the airborne deployment and delivery of palletized cargo. The system includes a cargo pallet, one or more risers connected to the pallet, and an associated rigging. The risers are used in both stabilizing the cargo and in cushioning the impacts associated with transport and landing. The rigging is used in securing the pallet to one or more parachutes that are deployed as the pallet leaves the aircraft. The various components of the present system, and the manner in which they interrelate, are described in greater detail hereinafter.

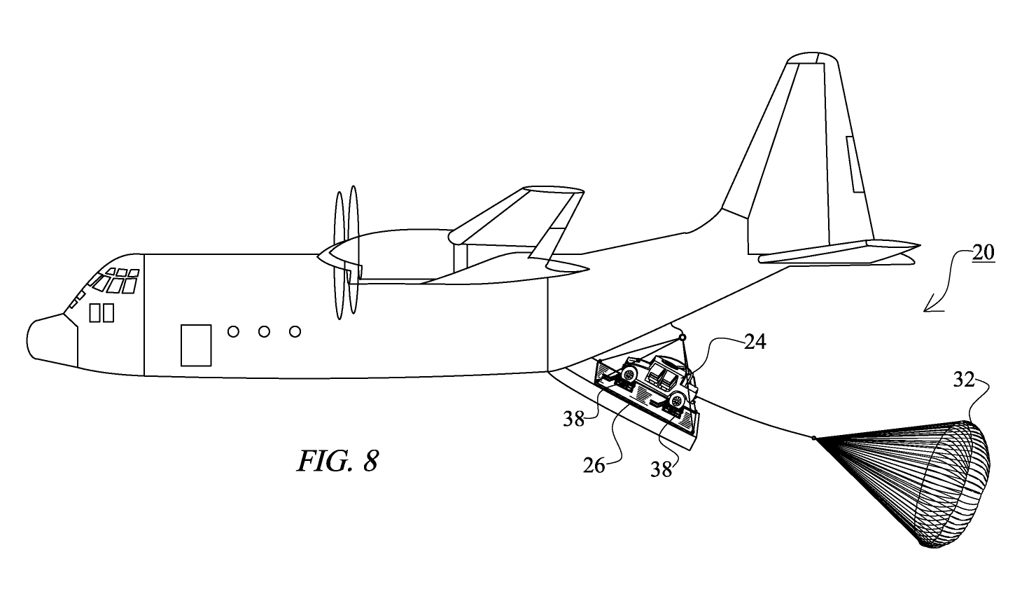

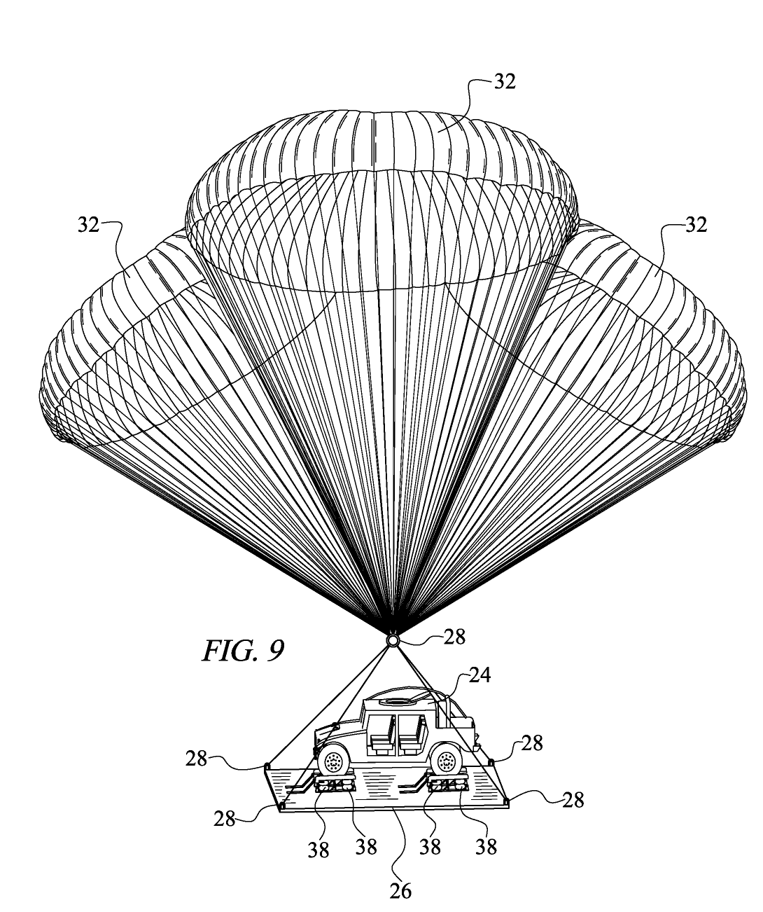

In the illustrated embodiment, the air drop system 20 includes four or more risers 22 that are utilized in securing a multi-wheeled vehicle 24 to an underlying pallet 26. More specifically, an individual riser 22 is secured to each of the wheels of vehicle 24 (or to other points, such as the frame). In the depicted embodiment, vehicle 24 is a High Mobility Multipurpose Wheeled Vehicle (HMMWV). Pallet 26, in turn, is secured to a parachute rigging 28 and parachute 32 (note FIG. 8). Rigging 28 may be interconnected to both an extraction parachute and one or more main parachutes. FIG. 8 illustrates an extraction chute pulling a palletized vehicle from the back of an aircraft. This arrangement allows the palletized vehicle 24 to be transported and subsequently dropped from the back of an aircraft such as a C-17 Globemaster or C-130 Hercules. As noted in more detail hereinafter, risers 22 are used in both securing vehicle 24 and in providing a pneumatic cushion.

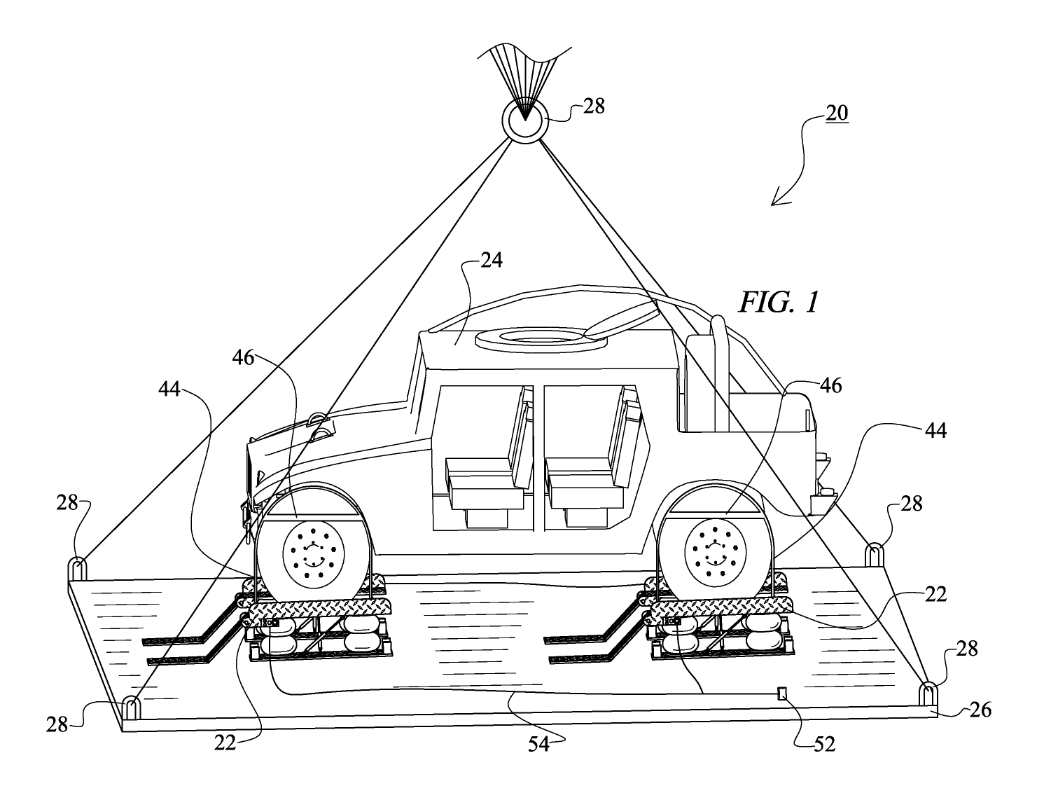

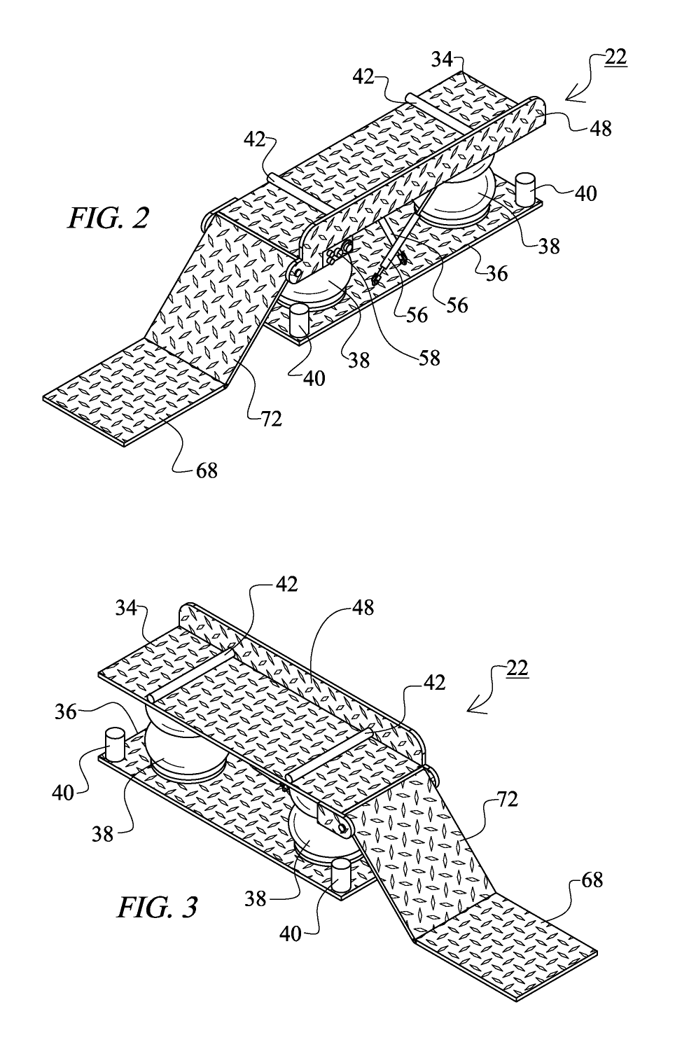

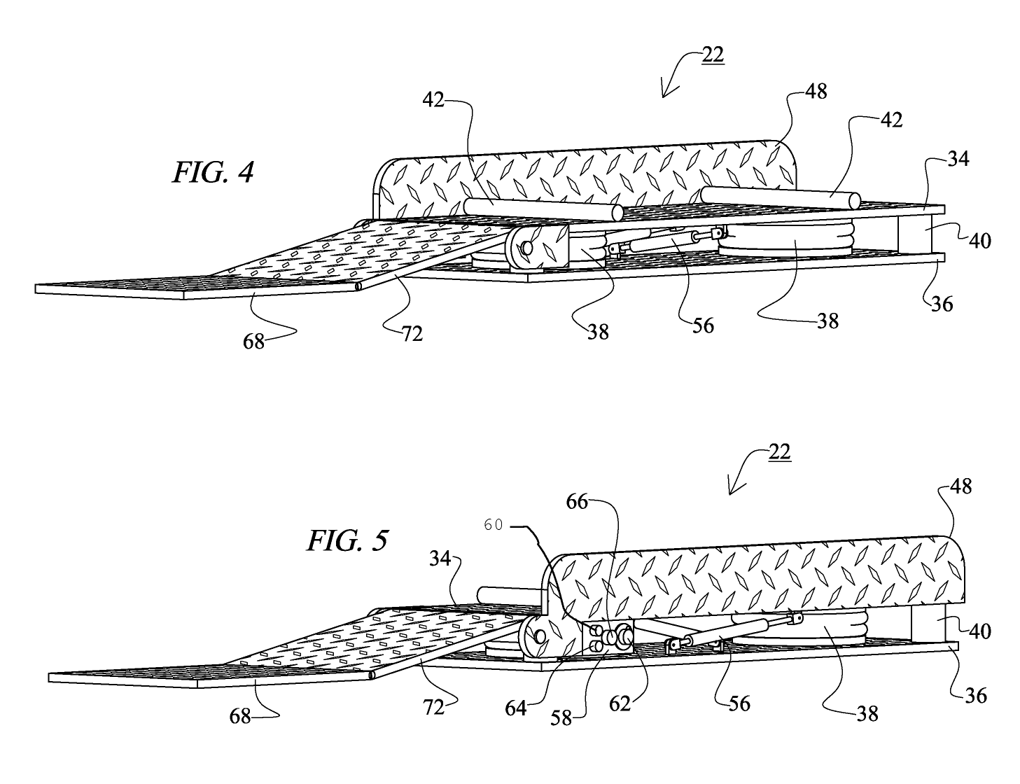

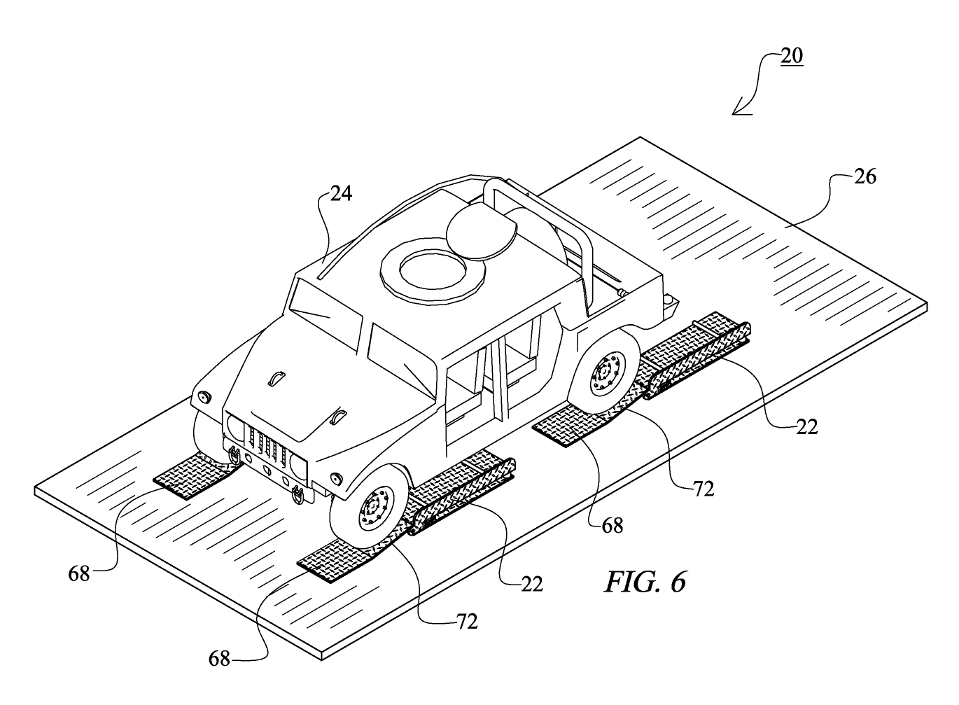

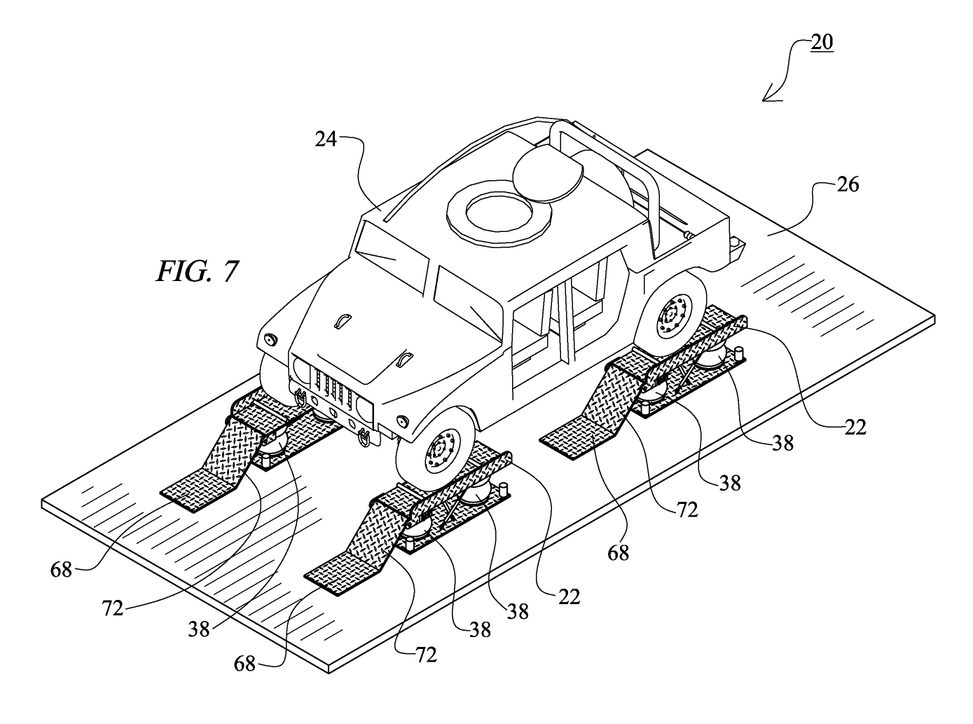

As illustrated in FIGS. 2 and 3, each riser 22 includes upper and lower platforms (34 and 36, respectively) that are separated by one or more pneumatic cushions 38. Cushions 38 can be air bags or airsprings. By inflating or deflating air bags 38, risers 22 can be selectively elevated or collapsed. Risers 22 may be embossed with a textured pattern to improve traction. Each lower riser platform 36 includes a rest 40, which can be made from a rubberized material, that is positioned within each of the four corners. Rests 40 provide clearance between the upper and lower platforms (34 and 36) when riser 22 is in the collapsed orientation. Upper riser platform 34 may additionally include opposing tire stops 42 for general centering of the vehicle 24 onto the riser. Tire straps are also secured to each of the upper riser platforms 34 (note FIG. 1). The straps include a first strap 44 that is adapted to be secured to the periphery of the tire and a second strap 46 that fits over the face of the tire. The opposing free ends are fastened to the upper platform 34. Buckles are preferably included to ensure that straps (44 and 46) can be tightly secured over the tire. By securing each of the four sets of straps to the wheels, vehicle 24 can be securely fastened to riser 22. Risers 22, in turn, are affixed to the underlying pallet 26 via bolts or quick release fasteners. The use of quick release fasteners permits the risers 22 to be positioned (or repositioned) upon underlying pallet 26 in variable configurations so that many types of cargo can be supported. Each upper platform 34 may also include an edge 48 along its outwardly facing side (note FIG. 2). A rear edge can optionally be included at the back of each upper riser 34. Upper and lower platforms (34 and 36, respectively) can be longer to accommodate multi-wheeled vehicles, treaded vehicles, or other land or water born craft. In this case, a series of air bags 38 can be used to support the elongated platforms.

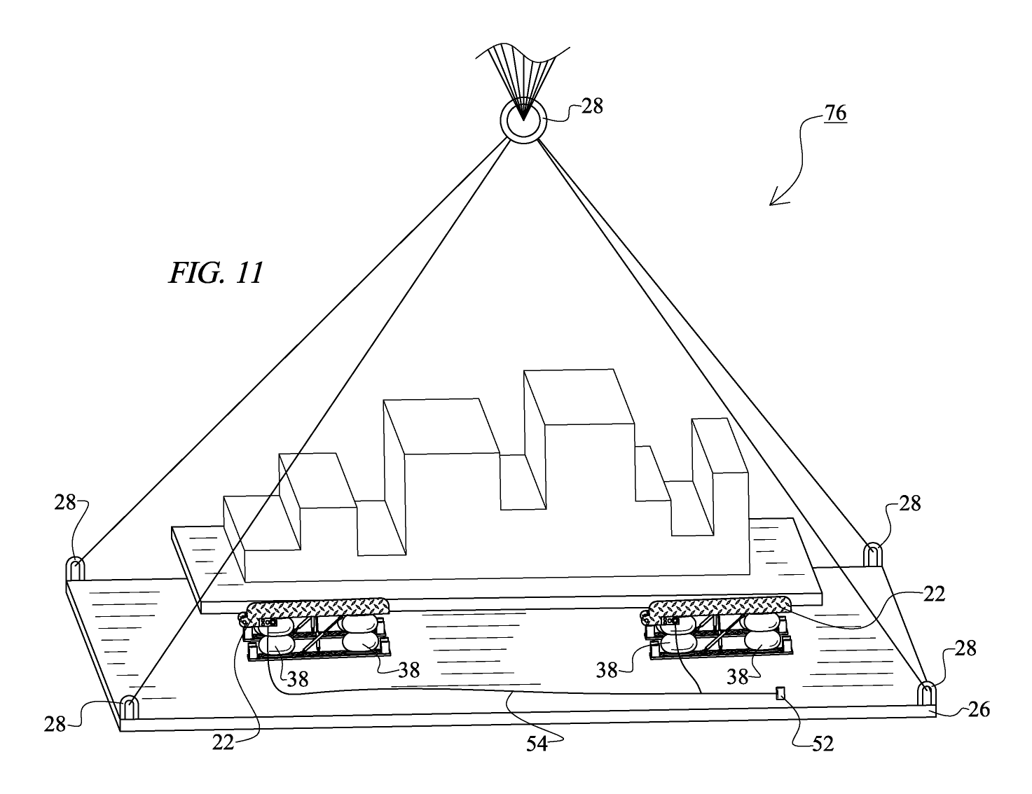

In the depicted embodiment, two air bags 38 are secured between each upper and lower platform (34 and 36). When inflated, air bags serve 38 to separate the upper and lower platforms (34 and 36) by approximately 10 inches. However, this distance can be increased or decreased depending on factors such as the degree of cushioning needed and the weight of the cargo. Air bags (34 and 36) provide a pneumatic cushion to the supported cargo. In the preferred embodiment, risers 22 employ commercially available off the shelf air cushions, such as those used in the suspension systems of tractor trailers. Such commercially available suspension systems can cushion the landing of up to 42,000 lbs (21 tons) of equipment. In the event that multiple risers 22 are employed, each of the air bags 38 are interconnected to a source of pressure 52 via tubing in an air circuit 54. In this regard, each riser 22 includes a quick disconnect port to couple air bags 38 to the common pressure source 52. This network 54 allows all of the risers 22 to be elevated or collapsed in unison. Pressure source 52 can be a container of pressurized air or an air compressor. Pressure source 52 can be mounted upon pallet 26 (FIG. 11) or it can be external. If pressure source 52 is external, it is removably coupled to network 54 to inflate air bags 38 prior to deployment. In the alternative, if source 52 is mounted on-board pallet 26, air bags 38 can be inflated after deployment or even after pallet 26 is ejected from the aircraft.

Shock absorbers 56 may also be secured between the upper and lower riser platforms (34 and 36) to reduce vehicle oscillation and to otherwise provide an added degree of stability to risers 22. Shock absorbers 56 can have a standard pneumatic or hydraulic piston/cylinder construction. Two or more shock absorbers 56 are preferably oriented in a cross wise fashion between the upper and lower platforms (34 and 36) of a single riser 22. More specifically, shock absorbers 56 are oriented between the opposing elongated side edges of the upper and lower platforms (34 and 36) so as to dampen the side to side movement (relative to the length) of the risers. This arrangement minimizes the sidewise movement of the mounted vehicle 24.

Each riser 22 also includes a control panel 58. Control panel 58 includes a quick disconnect port 60 for coupling air bags 38 to common pressure source 52. A gauge 62 is also included for showing the overall pressure within air circuit 54 as well as the pressure associated with specific air bags 38. A regulator valve 66 is used to control the pressure in the air bags 38 as well as the overall height of air bags 38. Control panel 58 also includes a vent 64 to provide a means of quickly deflating the associated riser(s) 22. A second quick disconnect, or network quick disconnect, (not shown) is located on the opposite side of the riser for connecting to the other risers during inflation and deflation. Orientation sensors, such as accelerometers or gyroscopes, can also be affixed to pallet 26 to sense the orientation of pallet 26 once on the ground. Depending upon the orientation of pallet 26, vents 64 associated with each riser 22 can be selectively deflated to keep vehicle level. Namely, if pallet 26 lands in rocky or uneven terrain, the height of risers 22 can be controlled via selective deflation of airbags 38 to prevent vehicle 24 from tipping and/or rolling over.

Although the disclosed embodiment has been described in connection with air bags or airsprings, other types of suspension systems can be employed. For instance, instead of pressurized air, bags 38 could be filled with a hydraulic fluid. Suitable hydraulic fluids may provide a greater degree of support over similar pneumatic systems. Furthermore, mechanical springs, such as coil or leaf springs, could also serve as a replacement for a hydraulic or pneumatic suspension system. A scissors-type lifting mechanism can optionally be used as a support mechanism. The number and configuration of risers 22 can be modified depending upon the nature of the cargo being transported. Risers 22 can be also be oriented to support varying parts of the cargo. For example, if the cargo is a vehicle, the vehicle frame can be supported as opposed to the wheels. Still yet other points can be supported for vehicles such as boats or aircraft. Still yet other riser configurations can be established for containers of differing size and shape. In sum, the number and configuration of risers 22 upon platform 26 can be selected to best support to cargo being transported.

Vehicle 24 can be driven onto risers 22 by way of hinged ramps. As illustrated in FIGS. 2 and 3, these ramps include two pivotally interconnected sections. The first section 68 is designed to lay relatively flat with the associated riser 22 in either the elevated or lowered position. The second section 72 is inclined, with the degree of incline increasing with the riser 22 in the elevated position. The inclined section 72 allows a vehicle to be driven up onto risers when they are in the collapsed orientation. This greatly reduces the time that would otherwise be needed for rigging or de-rigging vehicle 24 onto pallet 26. Namely, by way of the ramps (68 and 72), vehicle 24 can be easily driven onto or off of risers 22.

In use, vent 64 is used to evacuate the system pressure via control panel 58. Evacuating pressure from circuit 52, in turn, causes each of the four risers 22 to deflate and collapse. Vehicle 24 can then be driven onto risers 22 by way of the ramps (68 and 72). Straps (44 and 46) are then secured to each of the four tires. Additional straps can be used to provide a greater degree of support or to secure additional equipment to the pallet. Thereafter, quick disconnect valves 60 via control panel 58 are used to supply pressurized air to each of the air bags 38. With the bags 38 properly inflated, risers are elevated and vehicle 24 is supported above pallet 26. Alternatively, air bags 38 can be inflated after pallet 26 is deployed from the aircraft. In the preferred embodiment, vehicle 24 is supported at a height of about 10 inches over pallet 26 with the risers 22 elevated. After pallet 26 is dropped, a parachute 32, which is secured to the corners of pallet 26 via rigging 28, is deployed to slow the descent of the palletized vehicle 24. Upon impact, air bags 38 serve to pneumatically cushion the landing and thereby prevent damage to vehicle 24 and the associated equipment. Because air drop system 20 is designed to be reusable, any of a variety of extraction systems can be employed to recover system 20 after its use. In one non-limiting example, an extraction hoist can be lifted by a balloon to permit system 20 to be recovered by an aircraft.

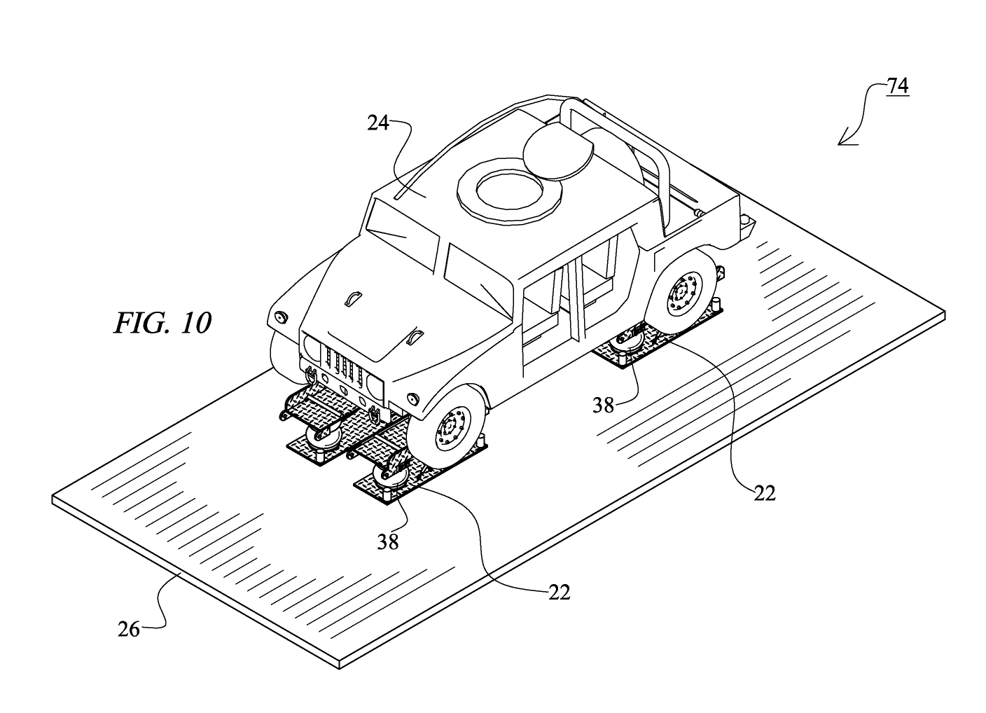

An alternative embodiment 74 is depicted in FIG. 10. In this system, risers 22 are spaced inwardly of the tires of the vehicle 24. In this manner, the risers 22 support the frame of vehicle 24 as opposed to the wheels. This embodiment provides a greater degree of support for the vehicle. Supporting the vehicle frame is also preferable because it reduces the height of the palletized vehicle 24. In use, vehicle 24 is driven onto pallet 26 and over top of risers 22. Care must be taken to ensure that deflated risers 22 are properly aligned with the underside of the vehicle chassis. Thereafter, airbags 38 are inflated such that risers 22 come into contact with chassis so as to lift vehicle 24. This embodiment is advantageous in that it eliminates the need for hinged ramps (68, 72) and also provides a greater degree of stability to vehicle 24. In still yet another embodiment 76, shown in FIG. 11, the risers are utilized in supporting boxes of cargo instead of a vehicle.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system for cushioning an air dropped four wheeled vehicle, the cushioning system comprising:
a pallet for supporting the vehicle, the pallet including upper and lower surfaces and four corners;
a set of four risers interconnected to the pallet, each of the four risers supporting one of the wheels of the vehicle, each of the risers comprising:
upper and lower platforms, the lower platforms being secured to the upper surface of the pallet;
a set of pneumatic cushions separating the upper and lower platforms;
forward and rearward tire stops attached to the upper platforms;
first and second hinged sections pivotally secured to the upper platforms;
a pair of shock absorbers interconnected between the upper and lower platforms;
a control panel with controls for regulating airflow into each of the pneumatic cushions;
a parachute and parachute rigging, the parachute rigging being releasably coupled to each of the four corners of the pallet;
a pneumatic circuit interconnecting each of the pneumatic cushions to a source of pressurized air, the pneumatic circuit being operated via the control panel;
each of the risers having a collapsed and an extended orientation, each of the pneumatic cushions being inflated with pressurized air in the extended orientation, each of the pneumatic cushions being deflated in the collapsed orientation, wherein the vehicle can drive on to and off of the four risers by way of the first and second hinged sections with the risers in the deflated orientation.

2. A system for cushioning air dropped cargo, the system comprising:
a pallet including upper and lower surfaces;
a riser supporting the cargo, the riser comprising:
upper and lower platforms, the lower platform being secured to the upper surface of the pallet;
a pneumatic cushion separating the upper and lower platforms;
a control panel for regulating airflow into the pneumatic cushion;
a parachute and parachute rigging, the parachute rigging being releasably coupled to the platform;
a pneumatic circuit interconnecting the pneumatic cushion to a source of pressurized air, the pneumatic circuit being operated via the control panel;
the riser having a collapsed and an extended orientation, the pneumatic cushion being inflated with pressurized air in the extended orientation and deflated in the collapsed orientation.

3. The system as described in claim 2 wherein the cargo is a four wheeled vehicle.

4. The system as described in claim 2 wherein the cargo is a four wheeled vehicle and wherein four risers are included for supporting each of the four wheels.

5. The system as described in claim 2 further comprising forward and rearward wheel stops on top of the upper platform.

6. The system as described in claim 2 further comprising a pair of shock absorbers positioned between the upper and lower platforms.

7. The system as described in claim 2 further comprising a set of stops positioned between the upper and lower platforms for providing a minimum spacing between the upper and lower platforms in the collapsed orientation.

8. The system as described in claim 2 wherein the upper platform of the riser is embossed for traction control.

9. The system as described in claim 2 wherein the cargo is a four wheeled vehicle and wherein four risers are included for supporting the frame of the vehicle.

10. The system as described in claim 2 wherein four risers are included and wherein first and second hinged sections are pivotally secured to each of the risers, whereby a vehicle can drive onto and off of the risers by way of the hinged sections.

11. A device for cushioning cargo, the device comprising:
a pallet including upper and lower surfaces;
a series of risers supporting the cargo, each of the risers comprising:
upper and lower platforms, the lower platform being secured to the upper surface of the pallet;
a set of cushions separating the upper and lower platforms;
a fluid circuit interconnecting each of the cushions to a source of pressurized fluid;
each of the risers having a collapsed and an extended orientations, with each of the cushions being inflated with pressurized fluid in the extended orientation and deflated in the collapsed orientation.

12. The device as described in claim 11 wherein the fluid is pressurized air.

13. The device as described in claim 11 wherein the fluid is pressurized hydraulic fluid.

14. The system as described in claim 11 wherein four risers are included and wherein first and second hinged sections are pivotally secured to each of the risers, whereby a vehicle can drive onto and off of the risers by way of the hinged sections.

15. The system as described in claim 11 further comprising a pair of shock absorbers positioned between the upper and lower platforms.

16. The system as described in claim 11 wherein the cargo is a four wheeled vehicle and wherein four risers are included for supporting each of the four wheels.

17. The system as described in claim 11 wherein the cargo is a four wheeled vehicle and wherein four risers are included for supporting the frame of the vehicle.
